(19) United States
(12) Patent Application Publication
(10) Pub. No.: US 2014/0063377 A1
(43) Pub. Date: Mar. 6, 2014

(54) AntiGlare Device

(71) Applicants: Donata Castelberg, Wadenswil (CH); Stefan Gunz, Au (CH); Manfred Castelberg, Schonenberg (CH)

(72) Inventors: Donata Castelberg, Wadenswil (CH); Stefan Gunz, Au (CH); Manfred Castelberg, Schonenberg (CH)

(21) Appl. No.: 13/879,463

(22) PCT Filed: Oct. 17, 2011
(86) PCT No.: PCT/CH2011/000244

§ 371 Date: Nov. 1, 2013

(30) Foreign Application Priority Data
Oct. 15, 2010 (CH) CH1690/10

(51) Int. Cl. G02F 1/133

(52) U.S. Cl. CPC G02F 1/13318
USPC 349/14

(57) ABSTRACT

Electro-optical glare protection device for protective glasses, protective helmets or protective masks comprising at least two optical sensors, which are equipped to detect the luminance of an object field and which have a different characteristic for the angle-dependent relative sensitivity (S₀). In particular, at least a first sensor comprises a first photodiode (1) having a narrow detection angle θ₁<45° and a second sensor comprises a second photodiode (2) with a wide detection angle θ₂>45°. An electronic circuitry for controlling the optical transmittance of a liquid crystal cell comprises differential circuit which generates a differential current (i_{Δ}) from photocurrents (i₁, i₂) generated by the respective photodiocies (1, 2), which differential current (i_{Δ}) serves as a control signal for controlling the liquid crystal cell.

Present invention is concerned with an electro-optical glare protection device for protective glasses, protective helmets or protective masks in accordance with the preamble of claim 1 and a method for operating such an electro-optical glare protection device,

Such anti-glare devices are well known for example from EP 550′384 or WO 03/106097 and are preferably used in welding masks. These anti-glare devices essentially comprise an optical filter arrangement having at least one liquid crystal cell, the optical transmittance thereof is controlled by an electronic circuit which uses the signal from a sensor in a desired manner. Unfortunately, these anti-glare devices prove not to be generally applicable and require complex electronics for their specific application.

Interfering workplace lightings, such as those generated by light tubes are suppressed with moderate success by so-called “Daylight Filters”. This “Daylight filters” are mounted on the sensors and absorb the flickering light at wavelengths of less than about 700 nm.

It therefore was already proposed by EP-0′579′076, resp. U.S. Pat. No. 5,880,793 to logical and/or temporal combine optical and non-optical sensors in a suitable combination, in order to detect interference, i.e. to separate interference signals from the useful signals and to filter them out from the specific control signals for the liquid crystal cells of the anti-glare shields used. All these known anti-glare devices are based on detecting a flicker, i.e. to identify rapid brightness changes of a few kHz, mostly in the infrared range. The optical sensors used therefore always detect the illuminance (Lux) of an object field only.

However, the attempts of today's welding machine manufacturers aim to the production of smooth and as small as possible torch flames. For this, the conventional filter arrangements are not particularly suitable and the recognizability of the brightness changes becomes even worse. In known devices, therefore the sensitivity of the sensors is increased, what increases not only the electronic complexity and required current consumption, but also leads to unintended darkening of the anti-glare shields.

A preferred use of such anti-glare devices in goggles is shown in WO-95/22074. The mechanical construction of such goggles is complex and leads to undesirable heavy products. In particular, the current guidance along several mutually separable components is susceptible to mechanical and chemical stress (shocks, humidity, etc.) as is known in the field of welding technology.

It is therefore an object of the present invention to overcome the disadvantages of the known anti-glare devices and in particular to create an anti-glare device and a method for operating such, which even in calm and less intense flame light and for a variety of applications even under extreme conditions is safely and for a long term usable without complex electronics.

This object is achieved in accordance with the invention by a glare protection device comprising the features of claim 1 and in particular with an electro-optical glare protection device comprising at least two optical sensors for detecting the luminance [cd/m2] of an object field, which sensors have a different characteristic for their angle-dependent relative sensitivity (S₀)—in the following also referred to detection lobe.

In a preferred embodiment of the present invention, the optical sensors comprise at least a first photodiode having a narrow detection angle θ₁<45° and a second photodiode having a wide detection angle θ₂>45°. Preferably, the photodiodes are provided with optically different refractive lenses.

The electronic circuitry for controlling the transmittance of the liquid crystal cell comprises a differential circuit, which differential circuit generates a differential current from the photocurrents generated by the respective sensors, or rather generates a differential signal which is supplied as a control signal to a comparator with internal or external reference.

It is understood that the electronic circuitry for controlling the transmittance of the liquid crystal cell may comprise a voltage divider between the differential circuit and the comparator.

In one embodiment of the present anti-glare device and according to the invention the comparator is permanently connected to the power supply and generates an input signal for the liquid crystal cell driving circuit only if a predetermined threshold value of the differential signal is reached. Thus, the electronic circuit for controlling the optical transmission of the liquid crystal cells is automatically switchable on and off, and the entire electronic circuit for controlling the optical transmission may be casted, for example, into the frame of the at least one liquid crystal cell.

The method according to the invention for operating such an electro-optical glare protection device is characterized in that a differential current is generated, by means of an electronic differential circuit, from the photocurrents generated by the at least two optical sensors—with different characteristics for the angle-dependent relative sensitivity—, which differential current controls the optical transmittance of a liquid crystal cell. The current thus generated is supplied to a comparator comprising an internal or external reference, the signal of which is controlling the optical transmittance of the liquid crystal cell.

The anti-glare device according to the invention can be used universally and is suitable for sunglasses, goggles for work—as they are used e.g. by goldsmiths for brazing—or for welding masks—as they are used for welding in the metal industry. In particular, the entire electronics, including power supply may be casted into the frame and the anti-glare device is thus protected against mechanical and chemical damage of any kind. Functionality is ensured for a long time, since the drive circuit for the at least one liquid crystal cell is activated only when a predetermined threshold value signal is available.

In the following, an embodiment will be explained in more detail and with reference to the figures. In the drawings:

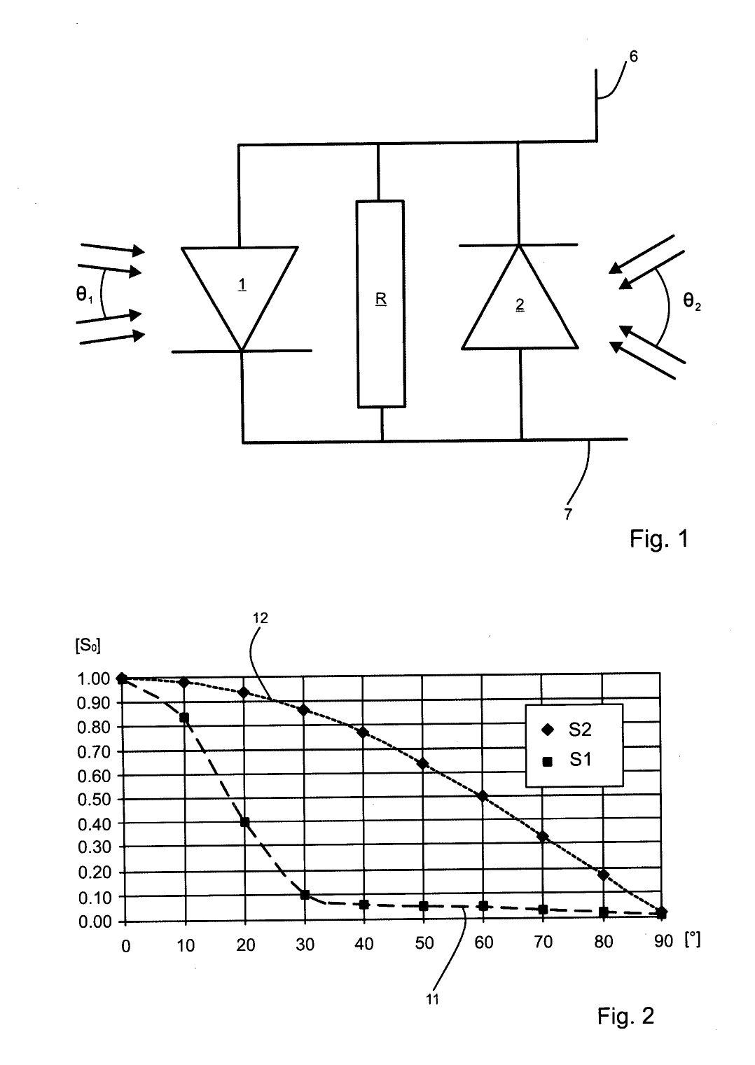

FIG. 1 shows a circuit diagram for generating a differential current according present invention and for controlling a liquid crystal cell;

FIG. 2 shows a diagram relating to the angular dependence of the relative sensitivity of the sensors;

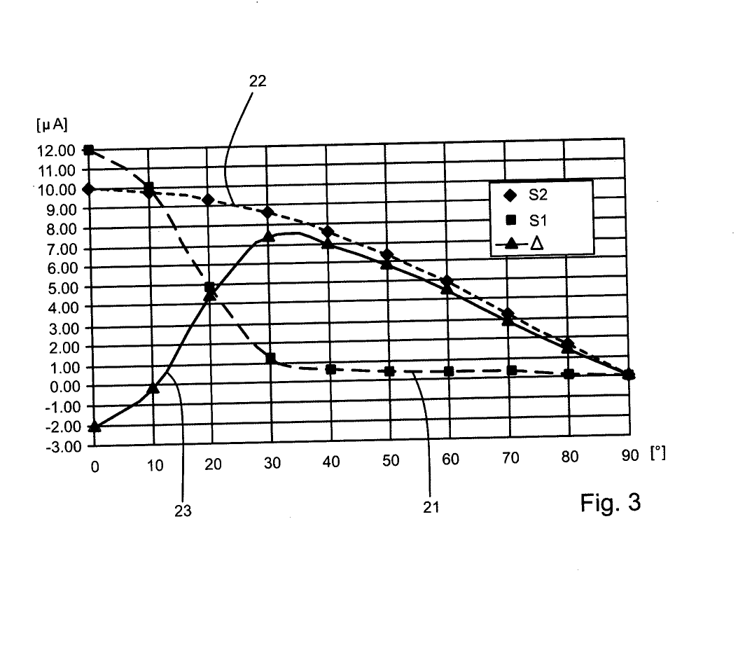

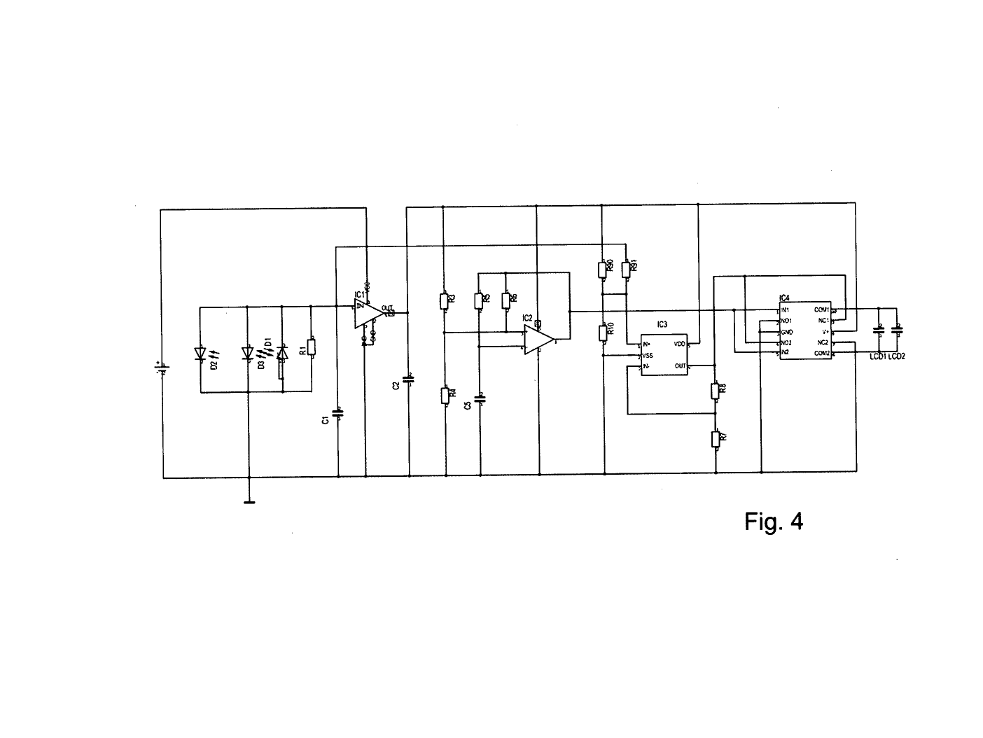

FIG. 3 shows a diagram relating to the angular dependence of the photocurrents of the sensors;

FIG. 4 shows a combining circuitry of preferred embodiments of the anti-glare device according to present invention.

The diagram shown in FIG. 1 shows a first simple embodiment of the electronic wiring of the optical sensors. A first sensor comprising a first photodiode 1 has a narrow detection angle θ₁, while a second sensor comprising a second photodiode 2 has a wide detection angle θ₂. In a preferred application the narrow detection angle θ₁ is approximately 30°, while the wide detection angle θ₂ is about 120°. These different detection angles can be adjusted by the man skilled in the art in a desired manner for the intended application by a suitable choice of commercially available photodiodes and/or by the attachment of appropriate optical lenses to these photodiodes. By the use of different detection cones or lobes the luminance [cd/m²] is detected for different detection fields. By the arrangement of the photo diodes 1 and 2 in parallel and in opposite directions their photo currents i₁, i₂ are subtractively superposed. The signals thus generated are supplied via conductors 6, 7 to a comparator (IC1), which generates a control signal for controlling the optical transmission of the liquid crystal cell (LCD). It is understood that this comparator is coupled with an external or internal reference.

A typical characteristic for the angular depending relative sensibility (S₀) of the photodiode used in accordance with the invention can be seen from the diagram in FIG. 2. The curve 11 shows the angle-dependent course of a first sensor S₁ with a narrow detection angle (θ₁<45°). This curve shows a high relative sensitivity S₀ within the half-angular range of 0° to 15°, resp. shows no relevant relative sensitivity S₀ within the half-angle range above 30°. In contrast, the course of the curve 12 for the relative sensitivity S₀ of a second sensor S₂ with a wide detection angle (θ₂>45°) shows very high values within the half-angle of 0° to 15°, which decrease continuously toward the half angle range of 90°.

The diagram shown in FIG. 3 makes clear the angle dependency of the respective photo currents i₁, i₂ of the sensors S₁, 3₂. The course of the curve 21 for the current strength [μA] of the photocurrent i₁ substantially corresponds to the course of the curve 11 in FIG. 1 for the angle-dependent relative sensitivity S₀ of the first sensor S₁ with a narrow detection angle θ₁. The course of the curve 22 for the current strength [μA] of the photocurrent i₂ substantially corresponds to the course of the curve 12 in FIG. 1 for the angle-dependent relative sensitivity S of the second sensor S₂ with a wide detection angle θ₂. Curve 23 shows the subtractive superposition of these two characteristics and makes it clear that by the detection of the different luminance [luminous intensity per unit area, cd/m²] instead of the illuminance [Lux] an exceptionally appropriate control signal can be generated in a surprisingly simple manner.

Preferred embodiments of the device according to the invention are shown in FIG. 4, and make clear the functioning. For the power supply a standard button cell battery, here a lithium cell battery with a capacity of 30 mAh is provided. It is understood that other power sources, in particularly solar cells, can be used, which usually require more space and thus greatly affect the original design of the goggles, protective helmets or masks. By using a suitable internal or external reference (luminance level) the comparator IC1 serves as a threshold switch, and generates at a predetermined luminance difference, in a first variant of this embodiment, a control signal which is further processed by a second comparator IC2 for use by the LCD drive circuit IC4. Thus, the at least one liquid crystal cell LCD1, LCD2 switches to a preset transmission value, when a comparator threshold is exceeded, which threshold is preset by an internal or external voltage divider and which transmission value is adapted to the use of the liquid crystal cell. The minimized power consumption achieved by the use of these comparators IC1, IC2 leads to a lifetime of up to 7 years for the currently commercially available button cell battery and allows to completely and waterproof cast all the electronics, i.e. power supply, sensors, electronic circuit and liquid crystal cell contacts. in a second variant of this embodiment, the differential current is supplied directly to an operational amplifier IC3, which is used as a dock generator for the LCD driver circuit IC4. This allows to continuously adjusting the optical transmission of at least one of the liquid crystal cells LCD1, LCD2, with the aid of the voltage signal, which is generated by the differential circuit (FIG. 1) in dependency of the luminance and is supplied via an operational amplifier IC3.

The desired circuitry can be assembled on a conventional printed circuit hoard by an expert in this field with the aid of pick and place robots for the one or other variant and can be further miniaturized and integrated into any socket or frame in a compact manner, in particular, at least the power supply, the two sensors and the electronic circuitry for controlling the optical transmission of at least one liquid crystal cell are integrated in such a frame or socket for the at least one liquid crystal cell. This allows use in the long term of the anti-glare device according to the invention in humid, corrosive or other environments usually damaging the electronics. In particular, an antiglare device can be achieved, which allows supplementing the optical glare protection with integrated electronics and which is firmly mounted into the socket or the frame by external interchangeable lenses. The outer protection glasses of such trendy designed goggles, helmets or masks are advantageously coated themselves and are pivotable upward to release the sensitive liquid crystal cells of the anti-glare device.

Other embodiments of this device according to the invention and method for operation thereof which are based on detection of the luminance of a working place lie within the normal acting of the skilled person.

The operation, construction and advantages of the present invention are immediately apparent to the skilled person from the present description and the accompanying figures and in particular are to be seen in that this device works permanent and is universally applicable, i.e. well suited for use in a pair of sunglasses, as in working goggles, for example for brazing of jewelry or for oxyacetylene welding of rails or boat hulls. The required protection level of up to 5 or 6, i.e. for an optical transmittance of approximately 1%, can be achieved easily with additional amplifiers. The aforementioned difficulties with the electronics fall away with present invention, for instance the suppression of low flicker frequencies, but especially the relatively fast, energy intensive an/or broadband amplifiers.

1. Electro-optical glare protection device for protective glasses, protective helmets or protective masks, comprising at least two sensors and an electronic circuit for controlling the optical transmission of at least one liquid crystal cell (LCD1, LCD2), characterized in that the at least two sensors are optical sensors (S1, S2) for detecting the luminance [cd/m²] of an object field, which sensors (S1, S2) have a different characteristic for the angle-dependent relative sensitivity (S₀).

2. Electro-optical glare protection device according to claim 1, characterized in that at least a first optical sensor (S1) has a detection angle of θ₁<45° and at least a second optical sensor (S2) has a detection angle θ₂>45°.

3. Electro-optical glare protection device according to claim 2, characterized in that the optical sensors (S1, S2) comprise photodiodes (1, 2), which are provided with different high-refraction optical lenses.

4. Electro-optical glare protection device according to claim 1, characterized in that the electronic circuitry for controlling the transmission of at least one liquid crystal cell (LCD1, LCD2) comprises a differential circuit which generates a differential current (i_{Δ}) from the photocurrents (i₁, i₂) generated by the respective sensors (S1, S2).

5. Electro-optical glare protection device according to claim 4, characterized in that the electronic circuitry for controlling the transmission of the at least one liquid crystal cell comprises a comparator (IC1, IC2) which receives the differential current (i_{Δ}) and comprises an internal or external reference.

6. Electro-optical glare protection device according to claim 5, characterized in that the electronic circuitry for controlling the transmission of the at least one liquid crystal cell (LCD1, LCD2) is adapted such that either a fixed transmission value or a variable transmission value is generatable.

7. Electro-optical glare protection device according to claim 1, characterized in that the electronic circuitry for controlling the optical transmission is switchable on and off with the aid of a permanently supplied threshold value switch (IC1).

8. Electro-optical glare protection device according to claim 1, characterized in that the electronic circuitry for controlling the optical transmission is integrated into the frame or socket thereof, i.e. is casted therein.

9. Method for operating an electro-optical glare protection device according to claim 1, characterized in that a differential current (i_{Δ}) is generated with the aid of an electronic differential circuit (FIG. 1) from photocurrents (i₁, i₂) which are generated by at least two sensors—with different characteristics for the angle-dependent relative sensitivity (S₀)—, which sensors are measuring the luminance [cd/m2] and which differential current (i_{Δ}) controls the optical transmission of at least one liquid crystal cell.

10. Protective goggles, protective helmets or protective mask with an electro-optical glare protection device according to claim 1, namely with at least two sensors (S1, S2) and an electronic circuitry for controlling the optical transmission of at least one liquid crystal cell (LCD1, LCD2), characterized in that the at least two sensors are optical sensors for the detection of luminance [cd/m2] of an object field which sensors have different characteristics for the angle-dependent relative sensitivity (S₀).
